(19) United States
(12) Patent Application Publication
(10) Pub. No.: US 2008/0264158 A1
(43) Pub. Date: Oct. 30, 2008

(54) Method for Determining Oil Dilution in a Internal Combustion Engine Featuring Post-Injection

(75) Inventors: Stefan Forthmann, Berlichingen (GB); Matthias Ziebell, Tuebingen (DE); Monika Scherer, Reutlingen (DE); Udo Kaess, Stuttgart (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 11/632,100

(22) PCT Filed: Jun. 2, 2005
(86) PCT No.: PCT/EP05/52534

§ 371 Date: Aug. 6, 2007

(30) Foreign Application Priority Data
Jul. 10, 2004 (DE) 10 2004 033 413.7

(51) Int. Cl. G01M 15/00

(52) U.S. Cl. 73/114.55

(57) ABSTRACT

A procedure to operate an internal combustion engine, whereby at least one fuel afterinjection is conducted, and a device to implement the procedure are proposed. An oil dilution signal is ascertained as a measurement for, for example, the volume of the oil dilution brought into the motor oil of the internal combustion engine by at least one fuel afterinjection. The fuel afterinjection, which is at least one in number, is, for example, so designed to introduce non-combusted fuel as combustible fuel into the exhaust gas area of the internal combustion engine, which reacts exothermally in the exhaust gas area to heat the exhaust gas treatment device.

### STATE OF THE ART

The invention proceeds from a procedure to operate an internal combustion engine, in which at least one fuel afterinjection is conducted, and from a device to implement the procedure according to the class of the independent claims.

From the German patent DE 199 06 287 A1 a procedure for the open-loop control of an internal combustion engine was made known, in whose exhaust area an exhaust gas treatment device is disposed, which contains a particle filter, that retains the particles contained in the exhaust gas. The particle load condition must be known for a proper operation of the particle filter. The aforementioned condition can be acquired indirectly by way of the pressure difference occurring at the particle filter or on the basis of model calculations.

The regeneration of a particle filter results by way of a flame cleaning of the particles collected in the particle filter. This takes place in a temperature range between, for example, 500° C.-650° C.

Provision is especially made, that fuel additionally enters into the exhaust area of the internal combustion engine, which reacts exothermally as combustible fuel in the exhaust gas area. The fuel is, for example, oxidized on the catalytically active surface area of a catalytic converter. On the one hand, the temperature of the catalytic converter thereby increases; and on the other hand, the temperature of the exhaust gas stream occurring behind the catalytic converter does likewise, whereby the subsequent particle filter is loaded. The fuel enters, for example, into the exhaust gas area by displacing the point of injection time of the fuel delivered to the internal combustion engine.

In the German patent DE 100 56 016 A1 a procedure to operate a particle filter is described, whereby fuel is likewise brought into the exhaust gas area of the internal combustion engine. This fuel reacts exothermally to heat the particle filter. The introduction of the fuel results from at least one non-burning fuel afterinjection, which can be influenced by the point in time related to crankshaft angle, by the time duration and by the fuel pressure. The time duration and the pressure yield the fuel amount per afterinjection.

As a function of the operating conditions in the combustion chambers of the individual cylinders of the internal combustion engine, the non-combusted fuel enters along the cylinder walls and around the piston rings into the crankcase. The fuel afterinjections can, therefore, contribute to a dilution of the oil.

A procedure to determine the amount of oil of an internal combustion engine was made known by the German patent DE 196 02 599 A1, whereby the oil level is measured with an oil sensor. The procedure allows for the oil level to be comparatively ascertained in an exact manner during the driving operation of a motor vehicle.

The task underlying the invention envisions a procedure to operate an internal combustion engine, whereby at least one fuel afterinjection is conducted, and is to specify a device to implement the procedure, which allows for a reliable operation of the internal combustion engine.

The task is solved in each case by the characteristics specified in the independent claims.

### ADVANTAGES OF THE INVENTION

The procedure according to the invention to operate an internal combustion engine assumes that at least one fuel afterinjection is conducted.

Provision is made according to the invention, that a signal processing ascertains an oil dilution signal as a measurement for the oil dilution brought into the motor oil of the internal combustion engine by at least the one fuel afterinjection. The measurement reflects, for example, the volume of oil dilution.

The fuel afterinjection, which is at least one in number, is, for example, intended to influence the running smoothness and/or the emissions performance of the internal combustion engine.

Provision can alternatively or additionally be made for a fuel afterinjection, which is at least one in number, in order to introduce non-combusted fuel into the exhaust gas area of the internal combustion engine. This non-combusted fuel is used as fuel to heat at least one exhaust gas treatment device disposed in the exhaust gas area of the internal combustion engine.

A significant advantage of the procedure according to the invention is that the oil dilution can be ascertained from the existing operational parameters of the internal combustion engine. A sensor is not required.

The knowledge of at least one measurement for the oil dilution caused by the fuel afterinjection, which is at least one in number, can be taken into consideration in order to increase reliability during operation of the internal combustion engine. For example, the oil dilution can be taken into account when ascertaining the oil level and/or the oil quality.

Advantageous embodiments and configurations of the procedure according to the invention result from the dependent claims.

Provision is made in a first embodiment to take a crankshaft angle signal into account when ascertaining the oil dilution. This signal indicates either the crankshaft angle related or the time related start of fuel injection of the fuel afterinjection, which is at least one in number.

Provision is made in another embodiment to take into account a time duration signal when ascertaining the oil dilution. This signal indicates a measurement of the time duration or the crankshaft angle range of the fuel afterinjection, which is at least one in number.

Provision is made in another embodiment to take into account a measurement for the amount of fuel delivered to the internal combustion engine with the fuel afterinjection, which is at least one in number, when ascertaining the oil dilution.

Provision is made in another embodiment to take into account a pressure signal when ascertaining the oil dilution. This signal indicates the fuel pressure in a metering device attached to the internal combustion engine.

Provision is made in another embodiment to take into account a status signal when ascertaining the oil dilution. This signal indicates the status of an exhaust treatment device disposed in the exhaust gas area of the internal combustion engine. The status signal signals, for example, that a regeneration of the exhaust gas treatment device is to be conducted, which requires the exhaust gas treatment device to be heated.

Provision is made in an embodiment to integrate an oil dilution signal supplied by an oil dilution ascertainment in an integrator to ascertain the oil dilution from a specified starting time point.

Provision is made to take into account an oil discharge stream signal supplied by an oil discharge ascertainment when ascertaining the oil dilution. The discharge of the motor oil resulting from the oil dilution can be taken into account with this measure. The dilution can especially occur when the engine is operating at heavy loads and/or at a high oil temperature.

Further embodiments are concerned with the additional analysis and evaluation of the oil dilution, which has been ascertained.

The device according to the invention concerns a control unit, in which the procedural sequence is deposited as a program. The control unit contains preferably a data storage medium, which, for example, is described with the program at the manufacturer's or by means of telecommunication, for example over the internet.

Additional advantageous embodiments and configurations of the procedural approach according to the invention result from additional dependent claims and from the following description.

### DRAWING

FIG. 1 shows a technical environment, in which a procedure according to the invention is operating.

FIG. 2 shows a fuel injection signal as a function of the crankshaft angle or the time.

FIG. 3 shows a block diagram of a signal processing, and

FIG. 4 shows a block diagram of a signal evaluation.

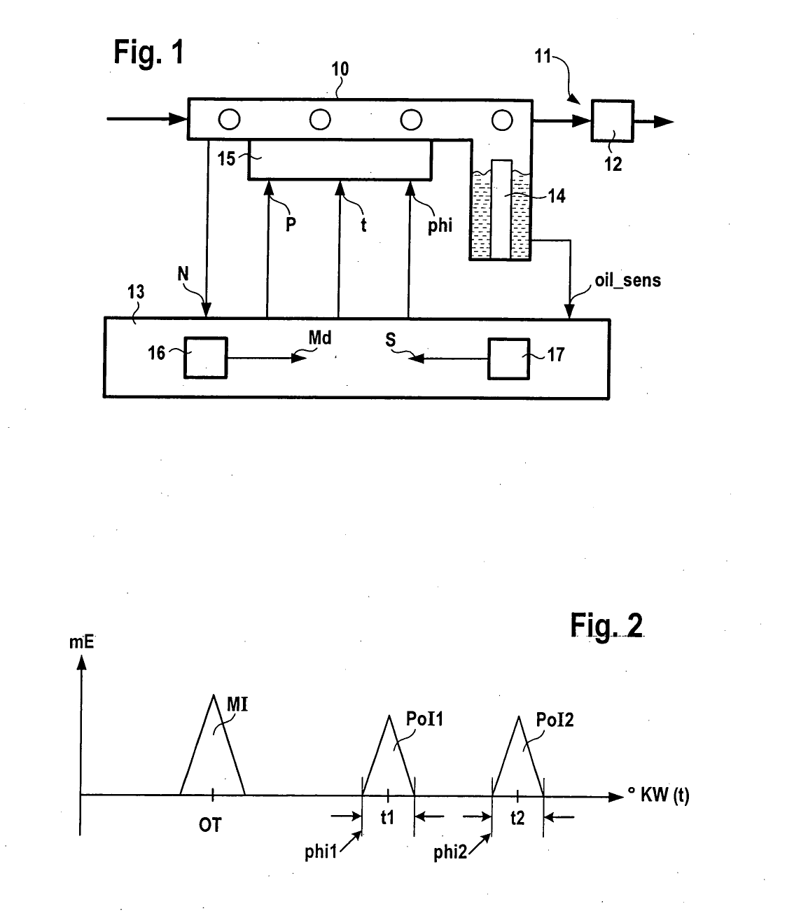

FIG. 1 shows an internal combustion engine 10, in whose exhaust gas area 11 an exhaust gas treatment device 12 is disposed. The internal combustion engine 10 emits an engine rotational speed signal N to a control unit 13. The internal combustion engine 10 contains an oil sensor 14, which provides an oil signal oil_sens to the control unit 13. A fuel metering device 15 is attached to the internal combustion engine 10. This device is supplied with a pressure signal p, a time duration signal t and an angle signal phi by the open loop control 13.

The open loop control 13 contains a torque calculation 16, which supplies a measurement for the torque Md to the internal combustion engine 10. The open loop control 13 contains further an exhaust gas treatment device status signal ascertainment 17, which provides a status signal S of the exhaust gas treatment device 12.

The pressure signal p, the time duration signal t as well as the angle signal phi can be designated compositely as the fuel injection signal mE. The fuel injection signal mE is shown in more detail in FIG. 2. In FIG. 2 a fuel main injection MI, a first fuel afterinjection PoI1 as well as a second fuel afterinjection PoI2 are plotted against the crankshaft ° KW. Instead of the crankshaft angle ° KW provision can be made for the aforementioned fuel injection and afterinjections to be plotted against the time t. The spacial and time based reference to top dead center OT of a reference cylinder of the internal combustion engine is essential. The fuel main injection MI lies in the range of top dead center OT. The first fuel afterinjection PoI1 begins at a first crankshaft angle phi1 and the second fuel after-injection PoI2 at a second crankshaft angle phi2. The first fuel afterinjection PoI1 has a first time duration t1, and the second fuel afterinjection PoI2 has a second time duration t2.

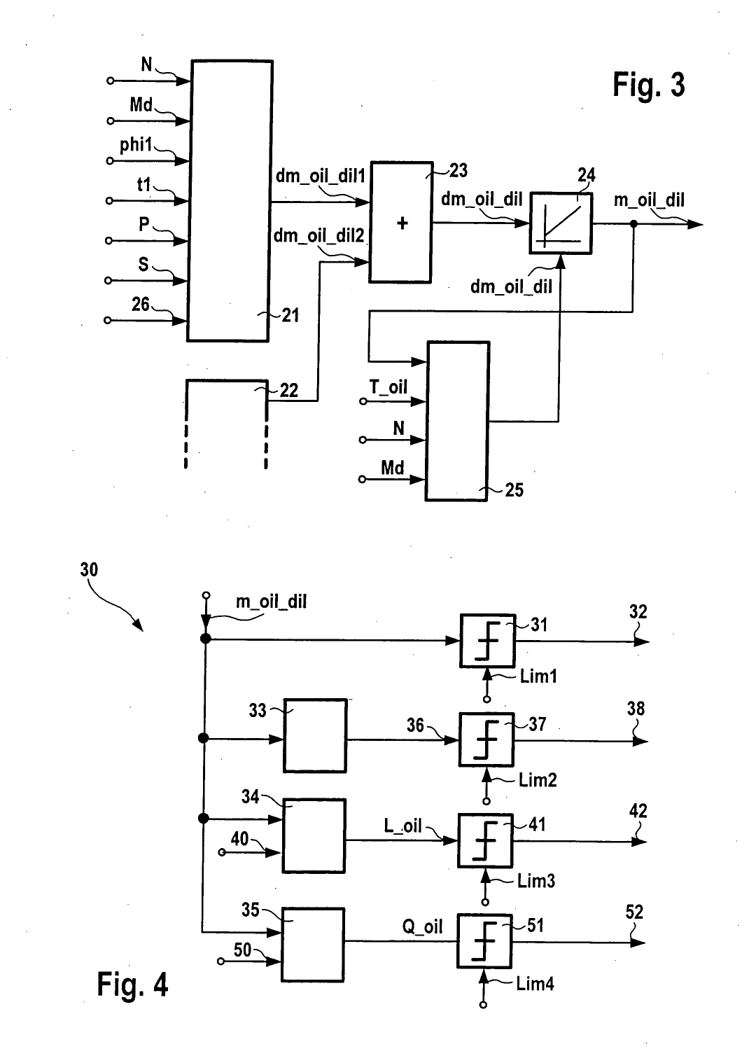

FIG. 3 shows a signal processing 20, which contains a first oil dilution ascertainment 21, a second oil dilution ascertainment 22, an oil dilution adder 23, an integrator 24 as well as an oil discharge ascertainment 25.

The engine rotational speed signal N, the measurement for the torque Md, the first crankshaft angle phi1, the first time duration t1, the pressure signal p, the status signal S as well as additional first input signals 26 are provided to the first oil dilution ascertainment 21. The first oil dilution ascertainment 21 transmits a first oil dilution stream signal dm_oil_dil1 to the oil dilution adder 23.

The oil dilution adder 23 receives a second oil dilution stream signal dm_oil_dil2 delivered from an unspecified second oil dilution ascertainment 22. The oil dilution adder 23 transmits a third oil dilution stream signal dm_oil_dil to an integrator 24, which is provided with an oil discharge stream signal dm_oil_dil by the oil discharge ascertainment 25. The integrator 24 provides an oil dilution signal m_oil_dil.

The oil dilution signal m_oil_dil, an oil temperature signal T_oil, the engine rotational speed N as well as the measurement for the torque Md are provided to the oil discharge ascertainment 25.

The oil dilution signal m_oil_dil ascertained in the signal processing 20 according to FIG. 3 is compared in the signal evaluation 30 depicted in FIG. 4 with a first threshold value Lim1 in a first comparator 31. The first comparator 31 provides a first warning signal 32.

The oil dilution signal m_oil_dil is additionally fed to an oil dilution alteration signal ascertainment 33, a fill level ascertainment 34 as well as an oil quality ascertainment 35.

The oil dilution alteration signal ascertainment 33 provides an oil dilution alteration signal 36, which a second comparator 37 compares with a second threshold value Lim2. The second comparator 37 provides a second warning signal 38.

The oil level ascertainment 34, which is provided with at least one additional oil level input signal 40, provides an oil level signal L_oil, which a third comparator 41 compares with a third threshold value Lim3. The third comparator 41 provides a third warning signal 42.

The oil quality ascertainment 35, which is provided with at least one additional oil quality input signal 50, provides an oil quality signal Q_oil, which a fourth comparator 51 compares with a fourth threshold value Lim4. The fourth comparator 51 provides a fourth warning signal 52.

The procedure according to the invention works in the following manner:

The torque ascertainment 16 establishes at least as a function of an unspecified input signal, which corresponds to a desired torque of the internal combustion engine, the measurement for the torque Md of the internal combustion engine 10. The engine rotational speed signal N as well as the measurement for the torque Md reflect individually or especially together the load state of the internal combustion engine 10. To adjust the measurement for the torque Md of the internal combustion engine 10, the open loop control 13 establishes the pressure signal p, the time duration signal t as well as the angle signal phi for the fuel metering device 15 as a function of a program deposited in the control unit 13.

The exhaust gas treatment device 12 is disposed in the exhaust gas area 11 of the internal combustion engine 10. This device contains, for example, at least one catalytic converter and/or at least one particle filter. Under certain operating conditions of the exhaust gas treatment device, an increase in the operating temperature of the exhaust gas treatment device 12 may be required. Such operating conditions include, for example, a required cleaning of undesirable exhaust gas components collected in the exhaust gas treatment device 12 within the scope of a regeneration of the exhaust gas treatment device 12. The exhaust gas treatment device status signal ascertainment 17 provides the status signal S at least when an increase of the operating temperature is required.

In the example of embodiment depicted, the temperature increase of the exhaust gas treatment device 12 is achieved by at least one fuel afterinjection PoI1, PoI2. The fuel afterinjection PoI1, PoI2, which is at least one in number, introduces the fuel as combustible fuel into the exhaust gas area 11. The fuel can react exothermally on a catalytically active surface, which is either present directly in the exhaust gas treatment device 12 or is disposed upstream from the exhaust gas treatment device 12. Provided that the catalytically active surface is present in the exhaust gas treatment device 12, the exhaust gas treatment device 12 is heated up directly. Provided that the catalytically active surface is disposed in front of the exhaust gas treatment device 12, the exhaust gas treatment device 12 is heated indirectly by the heated exhaust gas.

The fuel introduced into the exhaust gas area 11 by the fuel afterinjection PoI1, PoI2, which is at least one in number, can also react exothermally by the introduction of secondary air while forming a thermo-reactor area and thereby contribute to an increase in the exhaust gas temperature.

The pressure signal p, the time duration signal t as well as the angle signal phi together form the fuel injection signal mE, which is depicted more closely in FIG. 2. The main fuel injection MI takes place in the area of top dead center OT of a reference cylinder of the internal combustion engine 10, at which the injected fuel normally combusts completely and is converted to generate the torque of the internal combustion engine 10. The location of the main fuel injection MI can deviate from top dead center OT.

Provision is made for a first fuel afterinjection PoI1, which is supposed to begin at the first crankshaft angle phi1 and supposed to have a first time duration t1. Already in FIG. 2 it is indicated that the crankshaft angle ° KW can be replaced by the time t, whereby the time t likewise is to be referenced to top dead center OT. Similarly the first time duration t1 can be specified in units of crankshaft angle ° KW instead of in units of time.

The first fuel afterinjection PoI1 concerns, for example, a downstream fuel afterinjection, which on the one hand can be provided for the normal operation of the internal combustion engine 10; however, on the other hand can already be provided for the heating of the exhaust gas treatment device 12. The first fuel afterinjection PoI1 can, therefore, be established in such a way, that the injected fuel either still extensively combusts or only still partially combusts, so that at least a part of the fuel enters into the exhaust gas area 11 as combustible fuel.

Furthermore, provision can be made if need be for a second fuel afterinjection PoI2. The second fuel afterinjection PoI2 begins at the second crankshaft angle phi2 or at a specified time after top dead center OT. Similarly a crankshaft angle range can be specified for the second fuel afterinjection PoI2 instead of the second time duration t2. Generally the time durations t1, t2 establish in connection with the pressure signal p the injected amounts of fuel within the scope of the fuel afterinjections PoI1, PoI2.

The pressure signal p establishes the pressure of the fuel to be adjusted in the fuel metering device 15. The pressure signal p and the time duration t1, t2 determine the amount of fuel injected into the internal combustion engine 10 during the individual fuel injection processes.

The second afterinjection PoI2 concerns a late fuel afterinjection, whereby the fuel no longer combusts in the cylinders of the internal combustion engine 10 and enters extensively as combustible fuel into the exhaust gas area 11. If need be, provision can be made for additional fuel afterinjections.

The fuel afterinjections PoI1, PoI2 can lead to that point, where the fuel, which has not completely combusted, at least partially condenses on the combustion chambers of the individual cylinders of the internal combustion engine 10, runs down the cylinder walls as an oil dilution stream and enters into the motor oil. The oil dilution, which has thereby been caused, leads on the one hand to a change in the oil level and on the other hand to a change in the quality of the oil.

It is the goal to provide the oil dilution signal m_oil_dil, which is a measurement for the amount of oil dilution resulting from the fuel afterinjection PoI1, PoI2, which is at least one in number. In this instance the mass or the volume of the oil dilution may be concerned.

To begin with the first oil dilution stream signal dm_oil_dil1 is ascertained in the first oil dilution ascertainment 21. Analogous to that, the second oil dilution stream dm_oil_dil2 is ascertained in the second oil dilution ascertainment 22. Provision is made in each case for the engine rotational speed signal N, the measurement for the torque Md, the first crankshaft angle phi1, the time duration t1, t2, the pressure signal p, the status signal S as well as at least the additional input signal 26 to be input signals.

By taking the engine rotational speed signal N and/or the measurement for the torque Md into account, a measurement for the load state of the internal combustion engine is taken into account.

The point in time, respectively the crankshaft angle phi1, phi2, at which the fuel afterinjection (which is at least one in number) begins, has a considerable influence on the oil dilution. Furthermore, the amount of fuel is crucial, which is delivered to the internal combustion engine within the scope of the fuel afterinjection PoI1, PoI2. The amount results from the pressure signal p as well as the time duration t1, t2.

Provision can be made, for example, for the engine coolant temperature, which approximately corresponds to the temperature of the internal combustion engine 10, and/or, for example, the oil temperature to be an additional input signal 26.

The oil dilution ascertainments 21, 22 ascertain the oil dilution stream signals dm_oil_dil1, dm_oil_dil2 using tables and/or characteristic curves and/or characteristic fields, which preferably have been ascertained at the time of application and before the putting into operation of the internal combustion engine 10 and deposited in the oil dilution ascertainments 21, 22.

The oil dilution adder 23 adds the oil dilution stream signals dm_oil_dil1, dm_oil_dil2 to the third oil dilution stream signal dm_oil_dil, which reflects the entire oil dilution stream. The integrator 24 ascertains the oil dilution signal m_oil_dil from the third oil dilution stream signal dm_oil_dil. The signal ascertained is at least a measurement for all of the oil dilution brought into the motor oil from a specified starting point. The measurement reflects, for example, the volume of the oil dilution.

The internal combustion engine 10 can have operating states, in which the oil dilution decreases. That can be based upon the fact, that the oil dilution resulting essentially from fuel has a higher steam-pressure and a lower boiling point temperature than the motor oil. The oil dilution can take place by an upgassing of the motor oil especially at an elevated oil temperature and/or during heavy loads on the internal combustion engine 10. The oil dilution can by way of an unspecified ventilation pipe of the internal combustion engine, which is connected to the air intake area of the internal combustion engine 10, be delivered again as fuel.

The engine rotational speed N and/or the measurement for the torque Md of the internal combustion engine 10 are provided to the oil discharge ascertainment 25. The load state of the internal combustion engine 10 is revealed from at least one and preferably from both signals N, Md.

Provided that the oil sensor 14 provides the oil signal oil_sens as a function of the oil temperature, a corresponding oil temperature signal T_oil can be offered to the oil discharge ascertainment 25. The oil discharge ascertainment 25 ascertains the oil discharge stream signal −dm_oil_dil, which has a negative signatory sign, likewise using deposited tables and/or characteristic curves and/or engine characteristic maps, which similarly have preferably been ascertained at the time of application before putting the internal combustion engine 10 into operation and have been deposited in the oil discharge ascertainment 25. The negative signatory sign of the oil discharge stream signal −dm_oil_dil assures that the integration in the integrator 24 leads to a reduction of the oil dilution signal m_oil_dil.

The oil dilution signal m_oil_dil can be evaluated according to different criteria in the signal evaluation 30. Provision is made in a first possibility with regard to signal evaluation for the oil dilution signal m_oil_dil to be directly compared with the first threshold value Lim1 in the first comparator 31. Provided that the threshold value Lim1 is exceeded, the first comparator 31 provides the first warning signal 32. The first warning signal 32 can be deposited in an unspecified error storage, can be used to activate a display, can be drawn upon to activate an oil change interval display, can be drawn upon to influence parameters (phi1, phi2, t1, t2) of a fuel afterinjection PoI1, PoI2, which is at least one in number, and can be used to alter the operating point of the internal combustion engine 10.

Provision is made in another possibility for the oil dilution signal m_oil_dil to be evaluated in the oil dilution alteration signal ascertainment 33 with regard to the time based progression, as, for example with regard to the slope and/or the gradient. The oil dilution alteration signal ascertainment 33 provides the oil dilution alteration signal 36, which the second comparator 37 compares with the second threshold value Lim2 and as a function of the comparison result provides if need be the second warning signal 38. The second warning signal 38 can like the first warning signal 32 be further used.

Provision is made in another possibility to take into account the oil dilution signal m_oil_dil when ascertaining the oil level. The oil dilution signal m_oil_dil is fed to the oil level ascertainment 34, to which furthermore at least the one additional oil level input signal 40 is delivered. The additional oil level input signal 40 can, for example, be drawn off from the oil signal oil_sens, provided that the oil sensor 14 provides a measurement for the oil level in the internal combustion engine 10. The third comparator 41 compares the oil level signal L_oil ascertained from the oil level ascertainment 34 with the third threshold value Lim3 and supplies the third warning signal 42 as a function of the comparison result. The third warning signal 42 like the first warning signal 32 can be further used.

Provision is made in another possibility to take into account the oil dilution signal m_oil_dil when ascertaining the oil quality. The oil dilution signal m_oil_dil is fed to the oil quality ascertainment 35, which furthermore is provided with at least the one additional oil quality input signal 50. The additional oil quality input signal 50 can, for example, be drawn off from the oil signal oil_sens, provided that the oil sensor 14 provides a measurement for the oil quality. The fourth comparator 51 compares the oil quality signal Q_oil ascertained from the oil quality ascertainment 35 with the fourth threshold value Lim4 and supplies the fourth warning signal 52 as a function of the comparison result. The fourth warning signal 52 like the first warning signal 32 can be further used.

1. A method of operating an internal combustion engine, during which at one fuel afterinjection is conducted, the method comprising an oil dilution signal as a measurement for the oil dilution brought into the motor oil of the internal combustion engine by at least one fuel afterinjection.

2. A method according to claim 1, wherein ascertaining includes using a crankshaft angle that indicates a fuel injection start, which is either crankshaft angle related or time related, of at least the one afterinjection.

3. A method according to claim 1, wherein ascertaining includes using a time duration that indicates a measurement for the time duration or the crankshaft angle range of at least the one afterinjection.

4. A method according to claim 1, wherein ascertaining includes using a measurement for the amount of fuel delivered to the internal combustion engine with at least the one afterinjection.

5. A method according to claim 1, wherein ascertaining includes using a pressure signal that indicates a fuel pressure in a fuel metering device attached to the internal combustion engine.

6. A method according to claim 1, wherein ascertaining includes using a status signal that indicates a status of an exhaust gas treatment device, which is disposed in an exhaust gas area of the internal combustion engine.

7. A method according to claim 1, wherein ascertaining includes providing an oil dilution stream signal, which is delivered to an integrators, which ascertains an oil dilution signal by integration.

8. A method according to claim 1, further comprising ascertaining an oil discharge that provides an oil discharge stream signal that indicates a measurement for a reduction of the oil dilution.

9. A method according to claim 8, wherein ascertaining an oil discharge includes using an oil temperature signal, an engine rotational speed signal of the internal combustion engine, or a measurement for a torque of the internal combustion engine.

10. A method according to claim 1, further comprising comparing an oil dilution signal to a first threshold value in a first comparator, and wherein the first comparator provides a first warning signal as a function of the comparison result.

11. A method according to claim 10, further comprising evaluating an oil dilution signal with regard to a signal progression, and in that a second comparator compares an oil dilution alteration signal with a second threshold value and provides a second warning signal as a function of the comparison result.

12. A method according to claim 1, further comprising ascertaining an oil level from an oil dilution signal.

13. A method according to claim 1, further comprising ascertaining an oil quality from an oil dilution signal.

14. A control unit associated with an internal combustion engine, the control unit ascertaining an oil dilution signal as a measurement for the oil dilution brought into the motor oil of the internal combustion engine by at least one fuel afterinjection.
